(19) United States
(12) Patent Application Publication
(10) Pub. No.: US 2009/0006234 A1
(43) Pub. Date: Jan. 1, 2009

(54) CERTIFICATION METHOD FOR ELECTRONIC PAYMENT AND ID AUTHENTICATION TERMINAL AND ATM

(76) Inventors: Yan Han, Guangdong Province (CN); Guangzhong Han, Guangdong Province (CN)

Correspondence Address: SCHMEISER, OLSEN & WATTS, 22 CENTURY HILL DRIVE, SUITE 302, LATHAM, NY, 12110, US

(21) Appl. No.: 12/097,897

(22) PCT Filed: Dec. 4, 2006
(86) PCT No.: PCT/CN06/03269

§ 371 Date: Jun. 18, 2008

(30) Foreign Application Priority Data
Dec. 22, 2005 (CN) 200510120774.9
Dec. 4, 2006 (CN) PCT/CN06/003269

(51) Int. Cl. G06Q 20/00

(52) U.S. Cl. 705/35

(57) ABSTRACT

A certification method for electronic payment and ID authentication terminal and ATM. When customer would be shopping and pay, the customer sent the electronic-payment certification information to the electronic-payment certificate authority in phone dialing mode, then said authority verifies this information and transmits the certification result to the ID authentication terminal in the merchant-end, the ID authentication terminal will authenticate the ID code supplied by the customer and determine if the payment would be done. ID authentication terminal includes ID code reading module, communication module, indication module and authentication module 5 which compares the ID code reading result with the certification result from the electronic-payment certificate authority.

### FIELD OF THE INVENTION

The present invention relates to a certification method for electronic payment and ID authentication terminal, more specifically, the present invention relates to a certification method which fulfills electronic payment quickly, and the special ID authentication terminal and ATM for said method.

### BACKGROUND OF THE INVENTION

As economy development, people use the currency to pay frequently. The credit card is a way to pay without cash, recently the IC card is also a non-cash media for payment, specially, as the mobile phone is used widely, it become a non-cash payment tool. The phone number is bound with the credit card number, the merchant send the packaged information (Mobile phone number+order number+amount) to a particular phone number of an electronic-payment certificate authority (or said information is sent by SMS), then the electronic-payment certificate authority launch a paying request to the customer's mobile phone, and transmit a success message to the merchant after the customer's confirmation. These prior arts have been disclosed by Chinese Patent 03116382.3 whose title is “Mobile payment realization by bank credit card binding SIM card of mobile telephone set”, wherein the bank and the mobile communication service supplier come to agreement, the mobile communication service supplier provides the binding mode service to the bank and set up and maintain the binding information servers and files. Therefore the credit card issued by the bank was bound with mobile phone SIM card, the information, such as the corresponding relationship between the credit card and SIM card, personal data and password, is memorized on the host computer of the mobile communication service supplier, the consume settlement program on the customer-end was also set up on the SIM card of mobile phone, the consumers can apply the binding mode mobile phone SIM card service while they apply the credit card. Once this kind of consumer carry out a deal, the merchant submit a settlement application with the relevant consumer's mobile phone number or credit card number to the bank through POS machine, thereafter the bank send a settlement advice to the consumer's mobile phone using the mobile communication service, the consumer confirm this settlement action by returning message with password, then the deal will be done after the bill printed from POS machine was signed by the customer.

The defects in the prior art are that the consume settlement program on the customer-end was set up on the mobile phone while payment, and it usual spend more time in the process of payment, therefore the existence is restricted.

### PURPOSE OF THE INVENTION

It is a purpose of the present invention to overcome the above drawback in the prior art and provide a certification method for electronic payment and ID authentication terminal which can do the business transaction between the customer, the merchant and the electronic-payment certificate authority in wire or wireless communication mode, the customer can be easy to choose the payment certification in advance using this certification method, and make a payment safety and conveniently.

### SUMMARY OF THE INVENTION

The above purposes are realized in following technical solution:

A certification method for electronic payment includes the following steps:
Step 1. Customer sends the certification information about electronic payment to the electronic-payment certificate authority in phone dialing mode while payment.
Step 2. The electronic-payment certificate authority verifies the information from the customer and determines whether to pay or not, then this result information will be transmitted to the terminal of the merchant, or the terminal of the merchant gets back the result information from the electronic-payment certificate authority.
Step 3. The merchant confirm if the payment is done according to said result information received by the terminal.

Said certification method for electronic payment, the dial phone number was bound with the account of the customer when said customer sends the certification information about electronic payment to the electronic-payment certificate authority in phone dialing mode while payment.

Said certification method for electronic payment, the dialed phone number was bound with the account of the merchant when customer sends the certification information about electronic payment to the electronic-payment certificate authority in phone dialing mode while payment.

Said certification method for electronic payment, the phone number or the account number of the customer is bound with ID code.

Said certification method for electronic payment, the certification information about electronic payment will be sent by the customer in phone dialing signal mode, or phone voice mode, or a combination of both modes.

Said certification method for electronic payment, the electronic-payment certificate authority transmits the result information in phone dialing signal mode, or phone voice mode, or a combination of both modes.

Said certification method for electronic payment, the terminal of the merchant gets back the result information from the electronic-payment certificate authority in phone dialing signal mode, or phone voice mode, or a combination of both modes. Said certification method for electronic payment, the merchant distinguishes the payer according to ID cord authentication result.

Terminal which fulfills said certification method for electronic payment, includes communication module, indication module, authentication module, said authentication module is connected to other modules respectively.

ID authentication terminal which fulfills said certification method for electronic payment, includes the ID code reading module connecting to said authentication module.

ATM or vending machine which fulfills said certification method for electronic payment, includes communication module, indication module, authentication module and cash/goods store and output module, said authentication module is connected to other modules respectively.

ATM or vending machine which fulfills said certification method for electronic payment, includes the ID code reading module connected to said authentication module.

Comparing the present invention with the prior art, the present invention can make the customer choose the payment certification in advance, and make a payment safety and conveniently. The present method allows customer send the payment certification information to the electronic-payment certificate authority in advance, the ID authentication terminal of the merchant receive and save the result information from the electronic-payment certificate authority, then the customer verifies the ID cord on that terminal, the payment certification procedure will be finished if the ID cord is correct. The present invention has some advantages: 1. Customer can send the information about payment quickly and conveniently, the ID authentication terminal can confirm for it real-time; 2. The present invention utilizes several communication mode and network technology supplied from telecom operators, overcome the defect such as long time for certificate, complex processing, high cost, and make electronic-payment to be used widely.

### BRIEF DESCRIPTION OF THE FIGURES

FIG. 1 is the system schematic diagram of the present invention. This system realizes the certification method for electronic payment in phone dialing mode according to the embodiment of the present invention;

FIG. 2 is the block diagram of ID authentication terminal of the present invention, and describes a preferred embodiment;

FIG. 3 is the block diagram of ATM terminal of the present invention, and describes another preferred embodiment.

### DETAILED DESCRIPTION OF EXEMPLARY EMBODIMENTS

The following is a further description of the present invention referring to the figures.

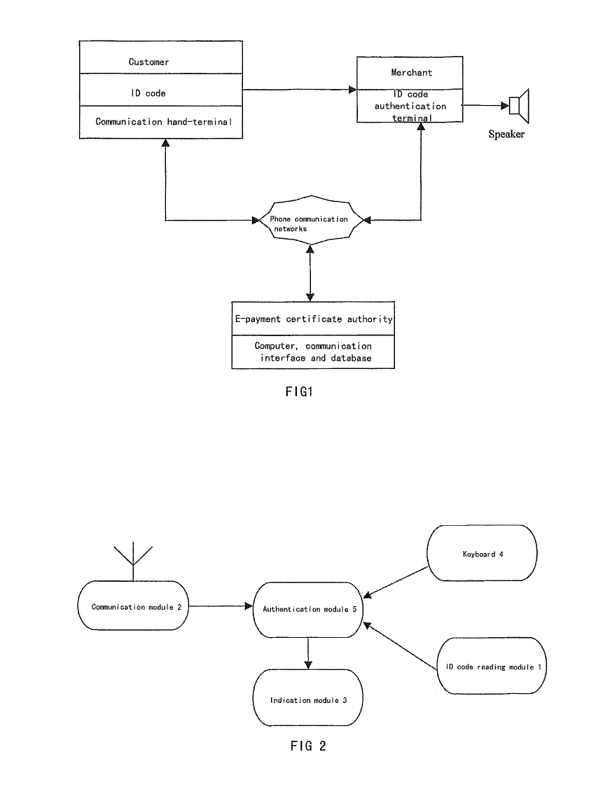

FIG. 1 is the system schematic diagram of the present invention. This system realizes the certification method for electronic payment in phone dialing mode according to the embodiment of the present invention. Referring to FIG. 1, this system includes customer, customer ID cord, communication hand-terminal/mobile phone, merchant, ID authentication terminal and equipments in the electronic-payment certificate authority.

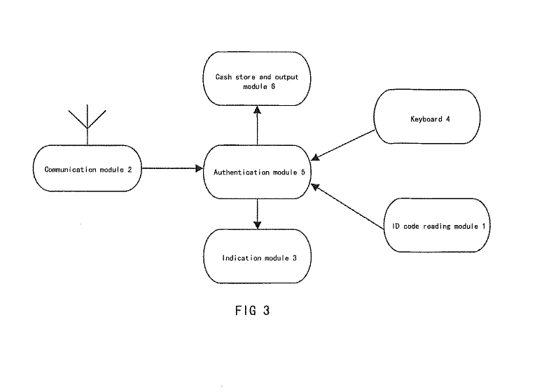

FIG. 2 is the block diagram of ID authentication terminal of the present invention, the ID authentication terminal includes ID code reading module 1, communication module 2, indication module 3, keyboard 4 and authentication module 5 which compares the ID code reading result with the result information from the electronic-payment certificate authority, the authentication module 5 is connected to other modules respectively.

The ID code reading module is used to read ID code supplied by customer, and will be different type for the different ID code carrier.

The ID code reading module will be Integrated Circuit (IC) card reader if the ID code carrier is IC card or intelligent encrypted IC card;

The ID code reading module will be wireless Radio Frequency (RF) card reader if the ID code carrier is wireless RF card;

The ID code reading module will be infrared receiver, magnetic card reader and barcode reader respectively if the ID code carrier is infrared transmitter, magnetic card and barcode card;

The ID code reading module will be radio signal receiver if the ID code carrier is radio communication hand-terminal;

The ID code reading module will be graphics signal receiving analyzer if the ID code carrier is radio communication hand-terminal LCD.

Communication module is used to communicate with the electronic-payment certificate authority for the certification information. The communication module will be phone modem if the communication is in phone communication mode.

Indication module is used to present the authentication result. The indication module can be the display, such as CRT, LCD or LED, which show paid amount, and can be the buzzer which prompt for the authentication result, and can be also the speaker to replace both display and buzzer, since Single Chip Computer can output the different digital audio signal to speaker through audio amplifier according the authentication result, therefore someone can identify the authentication result according the different sound from the speaker.

Keyboard is used to be input ID code on ID authentication terminal, and make the customer use electronic-payment way without ID code carrier.

Authentication module is used to compare the ID code reading result with the certification result information from the electronic-payment certificate authority. This module can be the Single Chip Computer (SCC), the special program inside SCC can compare the ID code reading result with the certification result information from the electronic-payment certificate authority, the authentication result includes paid amount. The authentication module has the function which authenticates the source of the certification result information only when ID code authentication was not required.

FIG. 3 is the block diagram of ATM terminal of the present invention, the ATM terminal includes ID code reading module 1, communication module 2, indication module 3, keyboard 4, authentication module 5 which compares the ID code reading result with the result information from the electronic-payment certificate authority, and cash store and output module 6, the authentication module 5 is connected to all above modules respectively.

Cash store and output module is used to output the relevant cash according to the result from the authentication module.

The functions of module 1 to module 5 in FIG. 3 consist with the same of FIG. 2.

The certification method for electronic payment is as following:

Customer sends the packaged information, such as merchant serial number, merchant trade code, customer account, customer password and trading amount, to the electronic-payment certificate authority through the access phone number of that authority in phone dialing mode using their phone or mobile phone while payment, the electronic-payment certificate authority authenticate if these information is valid and transmit the authentication result to the ID authentication terminal of the merchant, then the customer's ID code has to be authenticated at that terminal. If the ID code is approvable, the ID authentication terminal will make a positive sound and display the correct paid amount, so the merchant deem the customer has paid for this deal with a correct bill. Otherwise if the authentication result or ID code is not success for approval, the ID authentication terminal will make a warning sound, thus the merchant can deem the customer do not pay for this deal yet. The customer's password was set up for protecting the interest of customer, for example, somebody can not shop using your lost mobile phone therefore.

The following is a further description of the present invention referring to FIG. 1:

There are customer, customer ID cord, communication hand-terminal/phone, merchant, ID authentication terminal, electronic-payment certificate authority consisting of computer, communication interface and database, and phone communication networks.

The following are several steps in electronic-payment certification procedure.
Step 1. Customer sends the certification information about electronic payment to the electronic-payment certificate authority in phone dialing mode while payment.

Step 1 clarifies the integrated certification information about electronic payment should include merchant serial number, merchant trade code, customer account, customer password and trading amount.

If the electronic-payment certificate authority has bound the customer account with the relevant customer mobile phone number, the certification information about electronic payment sent by customer using mobile phone can include merchant serial number, customer password and trading amount only, since the customer mobile phone number already represents the customer account.

Furthermore, if each merchant was distributed a unique access phone number for electronic-payment application, the certification information about electronic payment sent by customer using mobile phone can include customer password and trading amount only, since the unique access phone number already represents the relevant merchant serial number, the customer mobile phone number represents the customer account too.

Merchant trade code may be also included in the certification information, because the merchant can manage every deal very well using this code and avoid any trading error. The information can be transmitted in wire phone communication mode or wireless phone communication mode, for example, customer sends the certification information about electronic payment to the electronic-payment certificate authority by wireless hand-phone terminal.

The certification information about electronic payment is also sent in phone voice mode. For example, if the customer account and the merchant serial number have not been bound with the number of mobile phone or phone, customer can dial the access phone number of the electronic-payment certificate authority, and send the packaged information such as the merchant serial number+customer account+customer password+amount after the reply of the authority, for this situation, Private Automatic Branch Exchange (PABX) forward this voice message to the electronic-payment certificate authority which can pick that voice message up in automatic response type. The transmission in phone voice mode can provide a perfect voice prompt service, specially, can add the voice authentication function for safety, but this mode of transmission spend more time and cost more talking fee.

The certification information about electronic payment is also sent in a combination of phone dialing signal mode and phone voice mode. For example, customer can dial the access phone number corresponding merchant in phone dialing signal mode, and send the packaged information such as customer account+customer password+amount in phone voice mode, for this situation, PABX forward the voice message to the electronic-payment certificate authority which can pick that voice message up in automatic response type. The transmission in phone voice mode can also provide a perfect voice prompt service, but the relevant talking fee should be charged.
Step 2. The electronic-payment certificate authority verifies the information such as customer account, customer password and amount, and determines whether to pay or not, then this result information will be transmitted to the terminal or the ID authentication terminal of the relevant merchant, or the terminal or the ID authentication terminal of the merchant gets back the result information from the electronic-payment certificate authority.

Step 2 clarifies the terminal or the ID authentication terminal of the merchant had a phone number which the electronic-payment certificate authority can communicate with, the terminal of the merchant also gets back the result information from the electronic-payment certificate authority. The certification result information can be transmitted in other wire communication mode or wireless communication mode, the transmission between the merchant terminal and the electronic-payment certificate authority could be realized in other data communication mode such as data communication and internet communication. The integrated certification result information should include merchant serial number, merchant trade code, customer ID code and trading amount. Due to the communication between the electronic-payment certificate authority and the merchant have been encrypted, which ensure the safe confirmation for both identities, so the simplest certification result information should be the trading amount that the merchant account would like to get, that is the trading amount+ID code, and the merchant trading code if required.

The certification information about electronic payment can be sent one-off in phone dialing signal mode, this implies that customer fingers a serial code on the keyboard of phone, or enter the information as text on the mobile phone and send out all. For example, the packaged information, such as the access phone number corresponding merchant+customer password+amount, are sent out to PABX and then are forwarded to the electronic-payment certificate authority which can receive the information automatically, the information is transmitted in phone dialing signal mode. This mode of transmission is fast and free-talking fee, but can not provide a perfect voice prompt service, and more access phone number in the electronic-payment certificate authority has to be provided as a relay station number.

If there was no ID authentication function on the terminal of merchant, it is not necessary for customer to provide their ID code to the merchant ID authentication terminal for authenticating.

The electronic-payment certificate authority transmits the certification result information to the terminal or ID authentication terminal of the merchant in phone dialing signal mode, or phone voice mode, or a combination of both modes.
Step 3. Customer provides their ID code to the merchant ID authentication terminal for authenticating. ID authentication terminal verifies the result information and the ID code, and determines whether the payment has been done, then makes some sound and/or displays the trading amount.

Step 3 clarifies the payment has been done if the ID authentication is approved, and the payment has not been done if the ID authentication is disapproved, that is, the requirements for electronic-payment have been fulfilled. The carrier type of customer ID code can be IC card, RF card, bar code card and magnetic card which were identified by the ID authentication terminal, as well as the characters or the particular graphics shown on LCD in some hand-equipments, or customer input the ID code on the keyboard of the ID authentication terminal. ID code will be held by customer themselves and was also memorized by the electronic-payment certificate authority. ID code can be encrypted for confidentiality and safety.

The ID code and the ID authentication terminal mentioned above are set up for more safety, because the authentication for ID will help the merchant to identify the customer's identity, and can fulfill a multi-customer prior-payment function which will be described further in the next embodiment about the multi-customer prior-payment for bus fare. However, high level safety is not required sometimes for electronic-payment such as the small amount transaction, as well as the merchant do not require the confirmation for customer's identity since the both parties were trading face to face, for this situation, ID code and ID authentication should not be required so long as the merchant can identify each payment from several customers, therefore the terminal of the merchant can not include the ID code reading module, the authentication module is just used to authenticate if the certification result information came from a correct source, and protect the interest of the merchant. This module can be the Single Chip Computer, the special program inside SCC will authenticate the source of the certification result information from the electronic-payment certificate authority, the authentication result includes paid amount which is shown on the indication module.

To strengthen the safety of electronic-payment certification, the electronic-payment certification authority can memorize and analyze the audio signal sample of customer's voice beforehand, the electronic-payment certification information sent by customer would include the audio signal of the real-time customer's voice to be used to authenticate the customer identity. Usually the voice authentication program would be used in the electronic-payment certificate authority, and verifies if the customer's voice correspond with the prior voice sample exactly, if only yes, this certification should be approved. So this is a good way to strengthen the safety of electronic-payment certification.

The bank builds up an electronic-payment certificate authority consisting of computer, phone communication network interface and database, to be connected to phone communication networks, the communication hand-terminal in customer-end and the terminal in merchant-end is also connected to phone communication networks. The electronic-payment certificate authority would memorize the customer's credit card number and the relevant account, password, ID code, the ID code would be held by customer for authenticating, and the customer's account for each customer is also bound with the relevant mobile phone number. The information such as the merchant serial number would be memorized in the electronic-payment certificate authority, each merchant serial number is also bound with an distributed access phone number which can be in mobile communication network or in wire phone communication network, thereafter the electronic-payment certificate authority will obtain the actual name of the customer and the merchant according to the dial phone number and dialed phone number, and the relevant accounts. The other form of the access phone number is the same front serial digits and the different rear serial digits, for example of the phone number 966888XXXXXX, the front 6 digits number are fixed and the rear 6 digits should be different and should be distributed to the different merchants. Binding phone number can reduce the communication volume for certificating, can be easy for certificate operation and minimize the time spending. The transmission between the electronic-payment certificate authority and the merchant terminal could be realized in other electronic communication mode.

When customer would be shopping and pay, the customer can sent a electronic-payment certification message, such as password and amount, to a relevant access phone number of the electronic-payment certificate authority in phone dialing mode, due to the merchant serial number has been bound with that access phone number, and the customer account has also been bound with their mobile phone number, the authority can find the relevant merchant serial number, customer account and password, and then verifies if the amount should be paid, and transmit the certification result to the ID authentication terminal in merchant-end immediately. The certification result information includes the memorized ID code and paid amount, customer input their ID code to ID authentication terminal for authenticating, ID authentication terminal will make a success sound and display the paid amount if the ID code from the authority consists with the ID code from customer.

For other situation, if the electronic-payment certificate authority verifies this payment is not valid, that is, the certification result to the ID authentication terminal in merchant-end is a rejection message which includes the ID code memorized by the authority and zero amount to be paid, customer input their ID code to ID authentication terminal for authenticating, although the ID code from the authority consists with the ID code from customer, the paid amount was zero, ID authentication terminal will make a long sound or voice and display zero amount, which signify the authority rejects this payment.

For further situation, if the ID code from the authority differs with the ID code from customer, ID authentication terminal will make a short sound and display zero amount.

The 3 kinds of authentication result mentioned above make customer and merchant know whether the payment was done, salesperson can verifies if customer has already paid the bill according to the result, that is, the requirements for electronic-payment have been fulfilled.

If the terminal mentioned above is used in taxi for paying fare, the ID code and ID authentication terminal should not be required here since this is a one-to-one trading. Customer sent the electronic-payment certification information such as taxi merchant serial number, customer account, customer password and amount to the access phone number of the electronic-payment certificate authority in phone dialing mode, the taxi merchant serial number is the taxi serial number. If the electronic-payment certificate authority approved this payment, the terminal in the taxi will be received the certification result information which includes paid amount, the taxi driver can verify if customer has already paid the bill according to the result. If the payment was rejected by the electronic-payment certificate authority, the terminal in the taxi will be received the certification result information which indicate zero amount. The wireless terminal in taxi is also the terminal which receives the certification result information from the electronic-payment certificate authority. To confirm safe receipt of the taxi fare, the result information will be transmitted to the terminal of the merchant, or the terminal of the merchant gets back the result information from the electronic-payment certificate authority. The terminal of the merchant also can obtain the certification result information from the electronic-payment certificate authority in wire phone communication mode or wireless phone communication mode.

The method for electronic payment of the present invention is also applicable to electronic-payment certification of the on-line business. When the customer understands the actual amount to be paid from internet, he/she should do the steps as following:
Step 1. Customer sends the certification information about electronic payment to the electronic-payment certificate authority in phone dialing mode while payment.
Step 2. The electronic-payment certificate authority verifies the information, and determines whether to pay or not, then this result information will be transmitted to the terminal of the relevant merchant, or the terminal of the merchant gets back the result information from the electronic-payment certificate authority.
Step 3. The merchant confirm if the payment is done according to said result information received by the terminal, the merchant will send out the goods if the payment was done. The terminal of the merchant also can obtain the certification result information from the electronic-payment certificate authority in wire phone communication mode or wireless phone communication mode.

There is the other embodiment about the multi-customer prior-payment for bus fare. The electronic-payment certificate authority has bound each customer account with the relevant customer mobile phone number, each bus is also bound with the unique access phone number of the electronic-payment certificate authority. If the bus fare is fixed, the certification information about electronic-payment sent by customer can be simplified, otherwise the information will exclude the amount. For example, there are 5 customers to send their password to the access phone number corresponding the bus serial number, if electronic-payment certificate authority approve these payments, then transmit 5 certification result information to the ID authentication terminal on the bus, these information are the memorized ID codes for 5 customers, customers input their ID code to ID authentication terminal for authenticating, ID authentication terminal will make a success sound and display paid amount if the ID code from the authority consists with the ID code from customer, the busman can verify if customer has already paid the fare according to the result. ID authentication terminal should delete this result information immediately after each ID code authentication in order to avoid any authentication repeat. The other one have not the relevant ID code so he was not success to pass the ID code authentication, the busman can verify this customer did not pay the fare. The process of ID authentication is very fast, usually spend for less 0.2 second. When the electronic-payment certificate authority rejects the payment or the ID code from the authority differs with the ID code from customer, the final process is same with said embodiment about shopping and paying. If said merchant serial number represents a bus team which use a same access phone number only, the electronic-payment certificate authority will transmit the certification result information to each ID authentication terminal on the buses if the payment was approved by the authority.

There is one of the embodiments for the certification method for electronic payment and ID authentication terminal of the present invention, referring to FIG. 2 which is the block diagram of ID authentication terminal, said terminal includes ID code reading module 1, communication module 2 and indication module 3, the module 1,2 and 3 are connected to authentication module 5 respectively, keyboard 4 is optional. Authentication module 5 compares the ID code reading result with the result information from the electronic-payment certificate authority, the authentication result is presented by the indication module 3.

When customer would be shopping and pay, the customer can sent an electronic-payment certification message, such as merchant serial number (shop serial number), customer account, password and amount, to a relevant access phone number of the electronic-payment certificate authority in phone dialing mode, the authority verifies if the amount should be paid, and transmit the certification result to the ID authentication terminal in merchant-end immediately. The certification result information includes the memorized ID code and paid amount, customer input their ID code to ID authentication terminal for authenticating, ID authentication terminal will make a success sound and display paid amount if the ID code from the authority consists with the ID code from customer.

For other situation, if the electronic-payment certificate authority verifies this payment is not valid, that is, the certification result to the ID authentication terminal in merchant-end is a rejection message which includes the ID code memorized by the authority and zero amount to be paid, customer input their ID code to ID authentication terminal for authenticating, although the ID code from the authority consists with the ID code from customer, the paid amount was zero, ID authentication terminal will make a long sound or voice or display a rejection message.

For further situation, if the ID code from the authority differs with the ID code from customer, ID authentication terminal will make a short sound or voice or displays zero amount and shows there are the different ID codes.

The 3 kinds of authentication result mentioned above make customer and merchant know whether the payment was done, salesperson can verify if customer has already paid the bill according to the result, that is, the requirements for electronic-payment have been fulfilled.

There is one of the embodiments for the certification method for electronic payment and ID authentication terminal and automatic teller machine (ATM) of the present invention, referring to FIG. 3 which is the block diagram of ATM terminal or vending machine, the withdrawable cash herein can be deemed as the goods by shopping, the ID authentication terminal in ATM includes ID code reading module 1, communication module 2, indication module 3 and cash store and output module 6, the module 1,2,3 and 6 are connected to authentication module 5 respectively, keyboard 4 is optional. Authentication module 5 compares the ID code reading result with the result information from the electronic-payment certificate authority, the authentication result is presented by the indication module 3.

Due to the ATM serial number has been bound with that access phone number, and the customer account has also been bound with their mobile phone number, when the customer would like to withdraw cash, the customer can sent an electronic-payment certification message, such as password and amount, to a relevant access phone number of the electronic-payment certificate authority in phone dialing mode, the authority verifies if the amount should be paid, and transmit the certification result to the ID authentication terminal in the ATM immediately. The certification result information includes the memorized ID code and paid amount, customer input their ID code to ID authentication terminal for authenticating, ID authentication terminal will make a success sound and display the amount to pay if the ID code from the authority consists with the ID code from customer, then the ATM will output cash to customer.

For other situation, if the electronic-payment certificate authority verifies this payment is not valid, that is, the certification result to the ID authentication terminal in ATM is a rejection message which includes the ID code memorized by the authority and zero amount to be paid, customer input their ID code to ID authentication terminal for authenticating, although the ID code from the authority consists with the ID code from customer, the paid amount was zero, ID authentication terminal will make a long sound or voice or display a rejection message.

For further situation, if the ID code from the authority differs with the ID code from customer, ID authentication terminal will make a short sound or voice or displays zero amount and shows there are the different ID codes.

The 3 kinds of authentication result mentioned above make customer know whether the payment was done, the requirements for ATM have been fulfilled. Said customer can sent the electronic-payment certification information to the electronic-payment certificate authority in phone dialing mode, or the authority transmit the certification result to the ID authentication terminal, all can be done in wire communication mode or wireless communication mode. The keyboard is used to be input the account and ID code by customer in the ID authentication terminal so that the customer without any ID carrier also uses this electronic-payment method in ATM.

If the ID reading module is not necessary, customer will not be required to input their ID code to ID authentication terminal.

What is claimed is:

1. A certification method for electronic payment, wherein said method includes the following steps:
Step 1. Customer sends the certification information about electronic payment to the electronic-payment certificate authority in phone dialing mode while payment.
Step 2. The electronic-payment certificate authority verifies the information from the customer and determines whether to pay or not, then this result information will be transmitted to the terminal of the merchant, or the terminal of the merchant gets back the result information from the electronic-payment certificate authority.
Step 3. The merchant confirm if the payment is done according to said result information received by the terminal.

2. A certification method for electronic payment according to claim 1, wherein the dial phone number was bound with the account of the customer when said customer sends the certification information about electronic payment to the electronic-payment certificate authority in phone dialing mode while payment.

3. A certification method for electronic payment according to claim 1, wherein the dialed phone number was bound with the account of the merchant when customer sends the certification information about electronic payment to the electronic-payment certificate authority in phone dialing mode while payment.

4. A certification method for electronic payment according to claim 1, wherein the phone number or the account number of the customer is bound with ID code.

5. A certification method for electronic payment according to claim 1, wherein said certification information about electronic payment will be sent by the customer in phone dialing signal mode, or phone voice mode, or a combination of both modes.

6. A certification method for electronic payment according to claim 1, wherein said electronic-payment certificate authority transmits said result information in phone dialing signal mode, or phone voice mode, or a combination of both modes.

7. A certification method for electronic payment according to claim 1, wherein said terminal of the merchant gets back said result information from the electronic-payment certificate authority in phone dialing signal mode, or phone voice mode, or a combination of both modes.

8. A certification method for electronic payment according to claim 1, wherein the merchant distinguishes the payer according to ID cord authentication result.

9. Terminal which fulfills said certification method for electronic payment according to claim 1, wherein said terminal includes communication module, indication module, authentication module, said authentication module is connected to all said modules respectively.

10. ID authentication terminal which fulfills said certification method for electronic payment according to claim 9, wherein said ID authentication terminal includes the ID code reading module connected to the said authentication module.

11. ATM or vending machine which fulfills said certification method for electronic payment according to claim 1, wherein said ATM or vending machine includes communication module, indication module, authentication module and cash store and output module, said authentication module is connected to all said modules respectively.

12. ATM or vending machine which fulfills said certification method for electronic payment according to claim 11, wherein said ATM or vending machine includes the ID code reading module connected to the said authentication module.
